(19) United States
(12) Patent Application Publication
(10) Pub. No.: US 2023/0206062 A1
(43) Pub. Date: Jun. 29, 2023

(54) ARTIFICIAL-INTELLIGENCE-BASED E-COMMERCE SYSTEM AND METHOD FOR MANUFACTURERS, SUPPLIERS, AND PURCHASERS

(71) Applicant: 10644137 CANADA INC., Calgary (CA)

(72) Inventor: Sam Scherwitz, Calgary (CA)

(21) Appl. No.: 17/923,452

(22) PCT Filed: May 4, 2021
(86) PCT No.: PCT/CA2021/050626

§ 371 Date: Nov. 4, 2022

Related U.S. Application Data
(60) Provisional application No. 63/019,854, filed on May 4, 2020.

(51) Int. Cl. G06N 3/08

(52) U.S. Cl. CPC G06N 3/08

(57) ABSTRACT

A computerized network system for facilitating e-commerce for multiple users. The system has at least one sewer computer; a plurality of client-computing devices used by the users; and a network coupling the server computer with the client-computing devices. The server computer has a database and an artificial intelligence (AI) module coupled to each other and both coupled to a data input/output interface in communication with the client-computing devices for repeatedly collecting e-commerce related data from a plurality of data sources, weighting the collected data from each data source based on the frequency of the data collection from the data source, repeatedly training the AI module using the collected data for optimizing one or more data-analysis models, analyzing the collected data using the one or more data-analysis models, generating predictions and identifying pre-verified users, and outputting the generated predictions and/or the pre-verified users to a graphic user interface (GUI).

### CROSS-REFERENCE TO RELATED APPLICATIONS

This application claims the benefit of U.S. Provisional Patent Application Ser. No. 63/019,854, filed May 4, 2020, the content of which is incorporated herein by reference in its entirety.

### FIELD OF THE DISCLOSURE

The present disclosure relates generally to a computerized network system and method for e-commerce between manufacturers, suppliers, and purchasers, and in particular to an artificial-intelligence-based e-commerce system and method for manufacturers, suppliers, and purchasers.

### BACKGROUND

With the fast evolution of interne technologies, electronic-commerce (also called “e-commerce) has become popular across the world, allowing people to buy and sell products and/or services online over the Internet. Generally, there are two types of e-commerce systems. The first type of e-commerce systems include those operated by companies and individuals for selling their own products and services.

The second type of e-commerce systems include trading platforms operated by third-party companies for sellers and buyers to trade thereon. In some e-commerce platforms, the operating companies thereof may also sell their own products thereon. Examples of such e-commerce systems include Amazon, eBay, Alibaba, and the like.

Existing e-commerce systems, in particular, the trading platforms with various buyers and sellers, face some transactional challenges and decision-making issues.

For example, it is difficult for corporate buyers, distributors, wholesalers and end-user consumers to pre-qualify manufacturers and/or suppliers of their company credentials and to procure products and/or services without tedious and costly methods for conducting background checks, procurement (with consideration of health, safety, environment, legal, and the like) processes, and verification of transactional parties' credentials. Buyers usually rely on ratings made by other buyers or alternatively of business-rating organizations/bureaus to evaluate the credibility and/or reliability of sellers. However, the ratings may often be incomplete and/or biased, and may not be sufficient for preventing fraud and fraudulence. On the other hand, sellers usually rely on proof-of-payments to confirm the credibility of buyers, which, however, may not be sufficient for preventing disputes and fraudulence.

In addition to the insufficiency of information available to buyers and sellers, there is also a large amount of misrepresentations, fraudulent, and/or misleading information provided by manufacturers around the globe in regard to their companies' credentials and/or product information and/or specifications and/or certifications.

Moreover, it is often, if not always, difficult for sellers to find bona fide and reliable customers for their products and services. The quality of customer leads should be every seller's number-one priority. There are billions of wasted marketing dollars spent annually on customers who do not fit within the targeted product demographics and/or credible. There are thousands of “lead generation” tools in the market but useless, inaccurate, and/or fraudulent data account for about 10% to 40% of customer leads online. Online leads generate a high quantity of poor-quality leads. Sellers spend billions of dollars buying customer lead lists that do not contain credible, qualified, and bona fide potential customers. Cold calling, mail campaign, inside sales reps, and other such marketing approaches do not provide sellers with a competitive advantage needed to survive via online sales of their products and services in the presently growing global digital marketplaces.

Thus, it is still an issue for business owners to successfully identify and engage online with qualified and trustworthy suppliers as well as with bona fide, credible and trustworthy customers from around the world.

### SUMMARY

According to one aspect of this disclosure, there is provided a computerized network system for facilitating a plurality of users in e-commerce; the system comprises: at least one server computer; a plurality of client-computing devices used by the plurality of users; and a network functionally coupling the at least one server computer with the plurality of client-computing devices; the at least one server computer comprises: a database, an artificial intelligence (AI) module functionally coupled to the database, the AI module comprising a neural network, and a data input/output interface coupled to the AI module and the database, and configured for communication with the plurality of client-computing devices; the database, the AI module, and the data input/output interface are configured for: repeatedly collecting data related to the plurality of users from a plurality of data sources, the data comprising one or more of history, regulatory compliance, certifications, public financial records, pricing records, shipping records, import & export records, purchasing records, reputation, customer testimonials, legal history, credibility, warranty and service terms; weighting the collected data from each data source based on the frequency of the data collection from the data source; repeatedly training the neural network of the AI module using the collected data for establishing and optimizing one or more data-analysis models; analyzing the collected data using the one or more data-analysis models; generating predictions based on the analysis of the collected data for pre-qualification of the plurality of users as suppliers, manufacturers, and products and service providers with verification information and ratings thereto; identifying pre-verified users from the plurality of users; and outputting the generated predictions and/or the pre-verified users to a graphic user interface (GUI).

In some embodiments, each of the one or more data-analysis models comprises: a structure for computing a prediction; weights of the collected data from each data source for said weighting the collected data from each data source; and biases of the collected data from each data source.

In some embodiments, the database, the AI module, and the data input/output interface are configured for: identifying demographic markets and online marketing vessels; providing marketing strategies and campaign plans; and generating marketing solutions based on the collected data and using the one or more data-analysis models.

In some embodiments, the database, the AI module, and the data input/output interface are configured for: providing links to points-of-purchase and/or to online ordering forms.

In some embodiments, the database, the AI module, and the data input/output interface are configured for: automatically identifying targeted content and targeted users based on said analyzing the collected data; and automatically sending the identified targeted content to the identified targeted users.

In some embodiments, said automatically sending the identified targeted content to the identified targeted users comprises: automatically sending the identified targeted content to the identified targeted users with a predefined frequency or a frequency adaptively determined based on said analyzing the collected data.

In some embodiments, the database, the AI module, and the data input/output interface are configured for: providing one or more of the pre-verified users an online directory or online store for branding, product management, logistics, and contract prices; ranking the one or more of the pre-verified users; and functionally connecting the pre-verified users for completing e-commerce transactions.

According to one aspect of this disclosure, there is provided a computerized method for facilitating a plurality of users in e-commerce using a database, an AI module, and a data input/output interface; the computerized method comprises: repeatedly collecting data related to the plurality of users from a plurality of data sources, the data comprising one or more of history, regulatory compliance, certifications, public financial records, pricing records, shipping records, import & export records, purchasing records, reputation, customer testimonials, legal history, credibility, warranty and service terms; weighting the collected data from each data source based on the frequency of the data collection from the data source; repeatedly training the neural network of the AI module using the collected data for establishing and optimizing one or more data-analysis models; analyzing the collected data using the one or more data-analysis models; generating predictions based on the analysis of the collected data for pre-qualification of the plurality of users as suppliers, manufacturers, and products and service providers with verification information and ratings thereto; identifying pre-verified users from the plurality of users; and outputting the generated predictions and/or the pre-verified users to a graphic user interface (GUI).

In some embodiments, each of the one or more data-analysis models comprises: a structure for computing a prediction; weights of the collected data from each data source for said weighting the collected data from each data source; and biases of the collected data from each data source.

In some embodiments, the computerized method further comprises: identifying demographic markets and online marketing vessels; providing marketing strategies and campaign plans; and generating marketing solutions based on the collected data and using the one or more data-analysis models.

In some embodiments, the computerized method further comprises: providing links to points-of-purchase and/or to online ordering forms.

In some embodiments, the computerized method further comprises: automatically identifying targeted content and targeted users based on said analyzing the collected data; and automatically sending the identified targeted content to the identified targeted users.

In some embodiments, said automatically sending the identified targeted content to the identified targeted users comprises: automatically sending the identified targeted content to the identified targeted users with a predefined frequency or a frequency adaptively determined based on said analyzing the collected data.

In some embodiments, the computerized method further comprises: providing one or more of the pre-verified users an online directory or online store for branding, product management, logistics, and contract prices; ranking the one or more of the pre-verified users; and functionally connecting the pre-verified users for completing e-commerce transactions.

According to one aspect of this disclosure, there is provided one or more non-transitory computer-readable storage devices comprising computer-executable instructions for facilitating a plurality of users in e-commerce using a database, an AI module, and a data input/output interface; the instructions, when executed, cause a processing structure to perform actions comprising: repeatedly collecting data related to the plurality of users from a plurality of data sources, the data comprising one or more of history, regulatory compliance, certifications, public financial records, pricing records, shipping records, import & export records, purchasing records, reputation, customer testimonials, legal history, credibility, warranty and service terms; weighting the collected data from each data source based on the frequency of the data collection from the data source; repeatedly training the neural network of the AI module using the collected data for establishing and optimizing one or more data-analysis models; analyzing the collected data using the one or more data-analysis models; generating predictions based on the analysis of the collected data for pre-qualification of the plurality of users as suppliers, manufacturers, and products and service providers with verification information and ratings thereto; identifying pre-verified users from the plurality of users; and outputting the generated predictions and/or the pre-verified users to a graphic user interface (GUI).

In some embodiments, each of the one or more data-analysis models comprises: a structure for computing a prediction; weights of the collected data from each data source for said weighting the collected data from each data source; and biases of the collected data from each data source.

In some embodiments, the instructions, when executed, cause the processing structure to perform further actions comprising: identifying demographic markets and online marketing vessels; providing marketing strategies and campaign plans; and generating marketing solutions based on the collected data and using the one or more data-analysis models.

In some embodiments, the instructions, when executed, cause the processing structure to perform further actions comprising: providing links to points-of-purchase and/or to online ordering forms.

In some embodiments, the instructions, when executed, cause the processing structure to perform further actions comprising: automatically identifying targeted content and targeted users based on said analyzing the collected data; and automatically sending the identified targeted content to the identified targeted users.

In some embodiments, said automatically sending the identified targeted content to the identified targeted users comprises: automatically sending the identified targeted content to the identified targeted users with a predefined frequency or a frequency adaptively determined based on said analyzing the collected data.

In some embodiments, the instructions, when executed, cause the processing structure to perform further actions comprising: providing one or more of the pre-verified users an online directory or online store for branding, product management, logistics, and contract prices; ranking the one or more of the pre-verified users; and functionally connecting the pre-verified users for completing e-commerce transactions.

### BRIEF DESCRIPTION OF THE DRAWINGS

FIG. 1 is a schematic diagram of an e-commerce system, according to some embodiments of the present disclosure;

FIG. 2 is a schematic diagram showing a simplified hardware structure of a computing device of the e-commerce system shown in FIG. 1;

FIG. 3 a schematic diagram showing a simplified software architecture of a computing device of the e-commerce system shown in FIG. 1;

FIG. 4 is a block diagram showing a functional structure of the e-commerce system shown in FIG. 1;

FIG. 5 is a flowchart showing the steps executed by the e-commerce system shown in FIG. 1 for analyzing data collected from various sources for facilitating online commerce;

FIG. 6 is a schematic diagram of a neural network used by the e-commerce system shown in FIG. 1; and

FIG. 7 shows a security architecture of the e-commerce system shown in FIG. 1, according to some embodiments of this disclosure.

### DETAILED DESCRIPTION

### System Overview

As described above, existing e-commerce systems, in particular, the trading platforms with various buyers and sellers (collectively denoted “parties”), have many disadvantages and/or issues, for example, available information for assessing parties and/or products is usually in various formats (including large amount of unstructured information) and in various contexts, thereby causing difficulties for existing e-commerce systems to analyze. There are also large amount of misrepresentations, fraudulent, and/or misleading information of various parties and/or products, which causes challenges for existing e-commerce systems and even knowledgeable human being to correctly identify and separate authentic information from misleading information. Such issues generally cause insufficient “high-quality” information for reliably identifying qualified parties and/or products.

Moreover, even existing e-commerce systems and even knowledgeable human being may be able to properly identify some authentic information for assessing various parties and/or products, with the increase of the scale and time-sensitivity of e-commerce, existing e-commerce systems and even knowledgeable human being face significant challenges in providing prompt and time-sensitive analyses to support e-commerce as required.

Embodiments disclosed herein relate to a computerized network system for solving at least some of the above-described issues. In particular, the computerized network system is configured for using artificial intelligence (AI) for:
verification and pre-qualification of manufacturers, product providers, and service providers;
automation of marketing and sales; and/or
providing a business shopping and supply center for an e-commerce community of pre-verified companies of various manufacturers, suppliers, and purchasers.

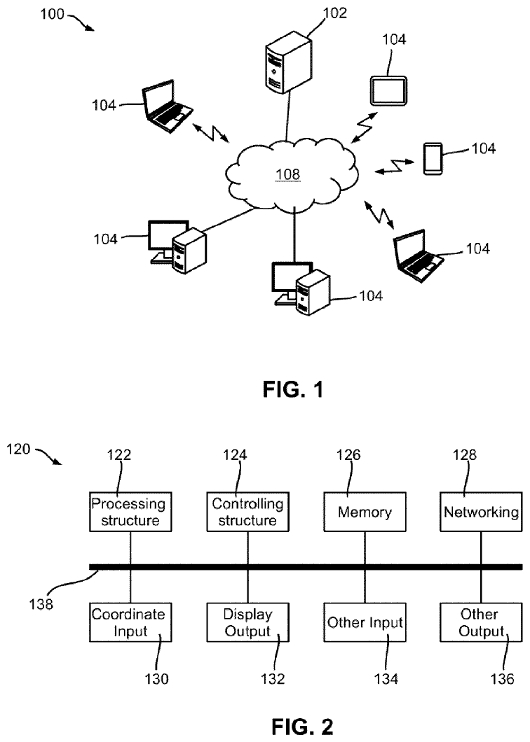

Turning now to FIG. 1, an e-commerce system in the form of a computerized network system is shown and is generally identified using reference numeral 100. The e-commerce system 100 has at least two types of users, including buyers and sellers of goods and/or services. As shown in FIG. 1, the e-commerce system 100 comprises one or more server computers 102 and a plurality of client computing devices 104 used by the buyers and sellers, all functionally interconnected by a network 108 such as the Internet, a local area network (LAN), a wide area network (WAN), a metropolitan area network (MAN), and/or the like, via suitable wired and wireless networking connections.

The server computer 102 executes one or more server programs. Depending on implementation, the server computer 102 may be a server-computing device and/or a general-purpose computing device acting as a server computer while also being used by a user.

Each client computing device 104 executes one or more client application programs (or so-called “apps”) for users to use. The client computing devices 104 may be desktop computers, laptop computers, tablets, smartphones, Personal Digital Assistants (PDAs) and/or the like.

Generally, the computing devices 102 and 104 have a similar hardware structure such as a hardware structure 120 shown in FIG. 2. As shown, the computing device 102/104 comprises a processing structure 122, a controlling structure 124, one or more non-transitory computer-readable memory or storage devices 126, a networking interface 128, coordinate input 130, display output 132, and other input and output modules 134 and 136, all functionally interconnected by a system bus 138.

The processing structure 122 may be one or more single-core or multiple-core computing processors such as INTEL® microprocessors (INTEL is a registered trademark of Intel Corp., Santa Clara, Calif., USA), AMD® microprocessors (AMD is a registered trademark of Advanced Micro Devices Inc., Sunnyvale, Calif., USA), ARM® microprocessors (ARM is a registered trademark of Arm Ltd., Cambridge, UK) manufactured by a variety of manufactures such as Qualcomm of San Diego, Calif., USA, under the ARM® architecture, and the like.

The controlling structure 124 comprises one or more controlling circuits such as graphic controllers, input/output chipsets and the like, for coordinating operations of various hardware components and modules of the computing device 102/104.

The memory 126 comprises a plurality of memory units accessible by the processing structure 122 and the controlling structure 124 for reading and/or storing data, including input data and data generated by the processing structure 122 and the controlling structure 124. The memory 126 may be volatile and/or non-volatile, non-removable or removable memory such as RAM, ROM, EPROM, EEPROM, solid-state memory, hard disks, CD, DVD, flash memory, and the like. In use, the memory 126 is generally divided to a plurality of portions for different use purposes. For example, a portion of the memory 126 (denoted as storage memory herein) may be used for long-term data storing, for example, for storing files or databases. Another portion of the memory 126 may be used as the system memory for storing data during processing (denoted as working memory herein).

The networking interface 128 comprises one or more networking modules for connecting to other computing devices or networks through the network 108 by using suitable wired or wireless communication technologies such as Ethernet, WI-FI® (WI-FI is a registered trademark of Wi-Fi Alliance, Austin, Tex., USA), BLUETOOTH® (BLUETOOTH is a registered trademark of Bluetooth Sig Inc., Kirkland, Wash., USA), ZIGBEE® (ZIGBEE is a registered trademark of ZigBee Alliance Corp., San Ramon, Calif., USA), 3G, 4G and/or 5G wireless mobile telecommunications technologies, and/or the like. In some embodiments, parallel cables (for example, parallel cables with DB-25 connectors), serial cables (for example, RS232 cables), USB connections, optical connections, and the like may also be used for connecting other computing devices or networks although they are usually considered as input/output interfaces for connecting input/output devices.

The display output 132 comprises one or more display modules for displaying images, such as monitors, LCD displays, LED displays, projectors, and the like. The display output 132 may be a physically integrated part of the computing device 102/104 (for example, the display of a laptop computer or tablet), or may be a display device physically separate from but functionally coupled to other components of the computing device 102/104 (for example, the monitor of a desktop computer).

The coordinate input 130 comprises one or more input modules for one or more users to input coordinate data, such as touch-sensitive screen, touch-sensitive whiteboard, trackball, computer mouse, touch-pad, or other human interface devices (HID) and the like. The coordinate input 130 may be a physically integrated part of the computing device 102/104 (for example, the touch-pad of a laptop computer or the touch-sensitive screen of a tablet), or may be a device physically separate from, but functionally coupled to, other components of the computing device 102/104 (for example, a computer mouse). The coordinate input 130, in some implementation, may be integrated with the display output 132 to form a touch-sensitive screen or touch-sensitive whiteboard.

The computing device 102/104 may also comprise other input 134 such as keyboards, microphones, scanners, cameras, Global Positioning System (GPS) component, and/or the like. The computing device 102/104 may further comprise other output 136 such as speakers, printers and/or the like.

The system bus 138 interconnects various components 122 to 136 enabling them to transmit and receive data and control signals to and from each other.

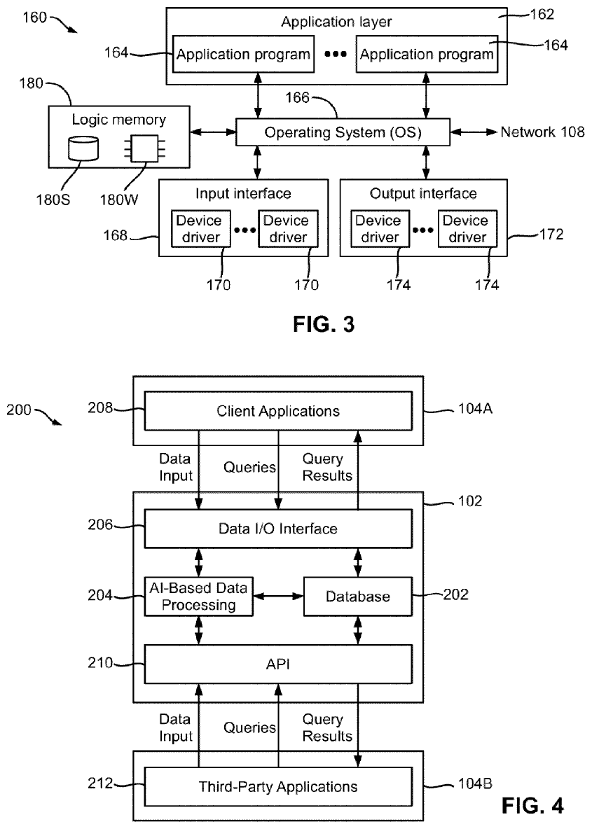

FIG. 3 shows a simplified software architecture 160 of the computing device 102 or 104. The software architecture 160 comprises an application layer 162, an operating system 166, an input interface 168, an output interface 172, and a logic memory 180. The application layer 332, operating system 336, input interface 338, and output interface 342 are generally implemented as computer-executable instructions or code in the form of software code or firmware code stored in the logic memory 350 which may be executed by the processing structure 302.

The application layer 162 comprises one or more application programs 164 executed by or run by the processing structure 122 for performing various tasks. The operating system 166 manages various hardware components of the computing device 102 or 104 via the input interface 168 and the output interface 172, manages the logic memory 180, and manages and supports the application programs 164. The operating system 166 is also in communication with other computing devices (not shown) via the network 108 to allow application programs 164 to communicate with those running on other computing devices. As those skilled in the art will appreciate, the operating system 166 may be any suitable operating system such as MICROSOFT® WINDOWS® (MCROSOFT and WINDOWS are registered trademarks of the Microsoft Corp., Redmond, Wash., USA), APPLE® OS X, APPLE® iOS (APPLE is a registered trademark of Apple Inc., Cupertino, Calif., USA), Linux, ANDROID® (ANDROID is a registered trademark of Google Inc., Mountain View, Calif., USA), and the like. The computing devices 102 and 104 of the e-commerce system 100 may all have the same operating system, or may have different operating systems.

The input interface 168 comprises one or more input device drivers 170 for communicating with respective input devices including the coordinate input 130. The output interface 172 comprises one or more output device drivers 174 managed by the operating system 166 for communicating with respective output devices including the display output 132. Input data received from the input devices via the input interface 168 is sent to the application layer 162, and is processed by one or more application programs 164. The output generated by the application programs 164 is sent to respective output devices via the output interface 172.

The logical memory 180 is a logical mapping of the physical memory 126 for facilitating the application programs 164 to access. In this embodiment, the logical memory 180 comprises a storage memory area (180S) that may be mapped to a non-volatile physical memory such as hard disks, solid-state disks, flash drives, and the like, generally for long-term data storage therein. The logical memory 180 also comprises a working memory area (180W) that is generally mapped to high-speed, and in some implementations volatile, physical memory such as RAM, generally for application programs 164 to temporarily store data during program execution. For example, an application program 164 may load data from the storage memory area 180S into the working memory area 180W, and may store data generated during its execution into the working memory area 180W. The application program 164 may also store some data into the storage memory area 180S as required or in response to a user's command.

In a server computer 102, the application layer 162 generally comprises one or more server-side application programs 164 which provide server functions for managing network communication with client computing devices 104 and facilitating collaboration between the server computer 102 and the client computing devices 104. Herein, the term “server” may refer to a server computer 102 from a hardware point of view or a logical server from a software point of view, depending on the context.

FIG. 4 is a schematic diagram showing the functionality structure of the e-commerce system 100. As shown, the server computer 102 of the e-commerce system 100 comprises a database 202 functionally coupled to an AI-based data-processing module 204.

Herein, the AI-based data-processing module 204 comprises one or more data-analysis models with each data-analysis model configured for a specific e-commerce process such as sales leads, buyer/seller verification, and the like. The AI-based data-processing module 204 may use data collected from various sources for training or otherwise optimizing the data-analysis models and pay use the trained data-analysis models for analyzing collected data and making predictions.

The database 202 and the AI-based data-processing module 204 are functionally coupled to a data input/output interface 206 for communication with client applications 208 executed on the client computing devices 104A for receiving data input from the client applications 208. The received data input may be processed by the AI-based data-processing module 204 and stored in the database 202. The data input/output interface 206 also may receive queries from the client applications 208 and, in response to the queries, may obtain query results from the AI-based data-processing module 204 (if the query results are not readily available) or from the database 202 (if the query results have been previously determined and stored in the database 202), and may return the obtained query results to the client applications 208.

The server computer 102 of the e-commerce system 100 also comprises an application programming interface (API) 210 functionally coupled to the database 202 and the AI-based data-processing module 204. In these embodiments, the API 210 may provide necessary programming interface for communication with one or more third-party applications 212 executed on one or more third-party applications 212 on third-party computing devices (which are generally considered herein as client computing devices 104B). By using the API 210, the server computer 102 may receive third-parties data from the third-party applications 212. The received third-party data is proceeded by the AI-based data-processing module 204 and stored in the database 202. The server computer 102 also may receive queries from the third-party applications 212 via the API 210, and may provide query results to the third-party applications 212 from the AI-based data-processing module 204 or the database 202.

Various hardware and software tools may be used to build the e-commerce system 100. For example, in some embodiments, the e-commerce system 100 may be built using the programming language Python with the use of a plurality of libraries such as:
the open-source machine-learning platform TENSORFLOW® 2.0 (TENSORFLOW is a registered trademark of Google LLC, Menlo Park, Calif., USA),
the open-source neural-network library Keras,
the ANACONDA® ecosystem (ANACONDA is a registered trademark of Anaconda Inc., Austin, Tex., USA), which allows processing data sets and graphically consuming the data, and
the GO® language (GO is a registered trademark of Google LLC, Menlo Park, Calif., USA), for building services and microservices for graphical user interface (GUI).

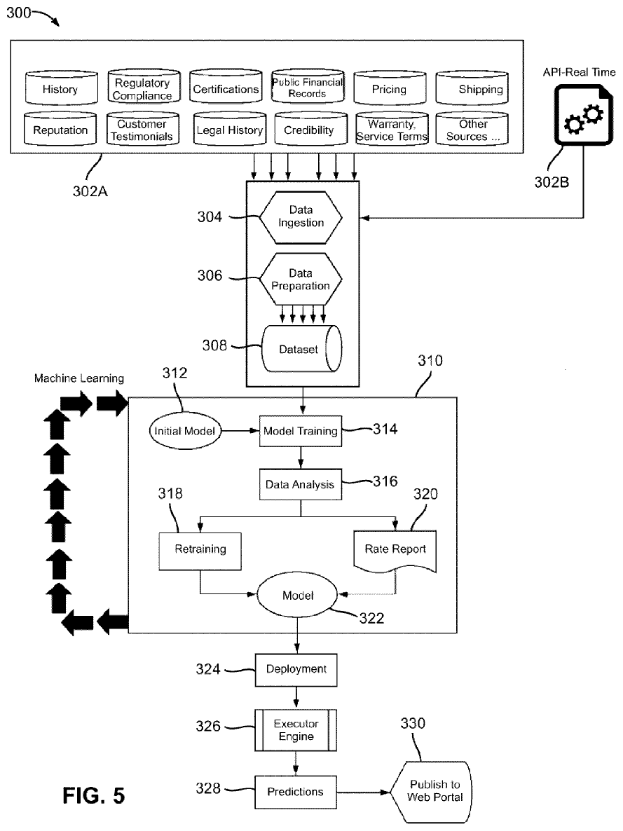

FIG. 5 is a flowchart 300 showing the steps executed by the e-commerce system 100 for analyzing data collected from various sources for facilitating online commerce. In these embodiments, the e-commerce system 100 is implemented and deployed as a software-as-a-service (SaaS) platform.

As shown in FIG. 5, the e-commerce system 100 may collect relevant data from users via the data input/output interface 206 and the client applications 208 (step 302A). The e-commerce system 100 may also collect relevant data from third parties via the API 210 and the third-party applications 212 in real-time (step 302B). At the data collection steps 302A and 302B, the e-commerce system 100 may allow data collection from unlimited data sources such as publically available data sources including big-data services and/or data sources obtainable with paid subscriptions.

A variety of e-commerce related data may be collected at steps 302A and 302B. For example, one or more of the following data of an entity (for example, a buyer or a seller) may be collected: history, regulatory compliance, certifications, public financial records, pricing records, shipping records, import & export records, purchasing records, reputation, customer testimonials, legal history, credibility, warranty and service terms, and other relevant data.

The e-commerce system 100 may execute the data collection steps 302A and 302B repeatedly or periodically with variable frequency of incremental data updates as needed such as at frequencies adapting to the data-update frequencies of various data sources. For example, the e-commerce system 100 may execute the data collection steps 302A and 302B at a high frequency or in real-time for some data sources that provide data updates in real-time. For some data sources that provide data updates at slower frequencies such as once a day or once a week, the e-commerce system 100 may execute the data collection steps 302A and 302B at the same frequencies.

In some embodiments, the collected data may be associated with a weight factor based on the data-update frequency of the corresponding data source for ensuring accurate analysis results.

At step 304, the collected data may be “ingested” in the e-commerce system 100 by going through a pre-processing sub-process. The data injection is managed by a micro-service architecture via APIs. The variables to ingest may be determined based on the data-analysis model to be optimized. At step 304, all data is ingested. Then, the data is prepared and transformed (step 306), and a dataset 308 is generated for subsequent consumption by the data-analysis model.

The dataset 308 is then analyzed using a suitable AI engine such as a machine-learning engine (step 310).

In particular, an initial data-analysis model 312 is created, and the machine-learning engine is trained based on the initial data-analysis model 312 and the dataset 308 (step 314).

After training, the pre-processed data is analyzed by the machine-learning engine using the data-analysis model (step 316). The analysis results obtained at step 316 are used for further training or retraining of the machine-learning engine (step 318) and are also used for generating a report such as a rate report having ratings of buyers and/or sellers (step 320). At step 322, the data-analysis model is updated. The data-analysis step 310 is then completed.

At step 324, the updated data-analysis model is deployed in the database 202 for use on the SaaS platform 100. At step 326, an executor engine uses the data-analysis model to further process data and create artifacts which are stored in a metadata store in the database 202. Predictions are then generated (step 328) and is published to an output such as a web portal of the SaaS platform (step 330).

In these embodiments, the AI-based data-processing module 204 uses a neural network such as a convolutional neural network (CNN) for establishing and updating the data-analysis model which is the representation of what the AI-based data-processing module 204 has learned from the training data. The data-analysis model generally comprise at least one of
the structure of how a prediction will be computed, and
the particular weights and biases (which are determined by training) of data; herein “biases” are the likelihoods that a piece of data is authentic information (or equivalently, the likelihoods that a piece of data is misleading information).

The AI-based data-processing module 204 may control a plurality of parameters of the data-analysis model to achieve a high model-capacity for learning and handling complex problems. As those skilled in the art will appreciate, while the e-commerce system 100 uses the data-analysis model to process collected data for data analysis and prediction, the e-commerce system 100 also may use collected data to train, or otherwise update and optimize, the data-analysis model. By using the machine-learning engine and the data-analysis model, the e-commerce system 100 may use various technologies such as optical text recognition (OCR), image recognition, audio recognition, pattern recognition, and/or the like to identify and separate authentic information of various parties and/or products from misrepresenting, fraudulent, and/or misleading information thereof, for assessing various parties and/or products.

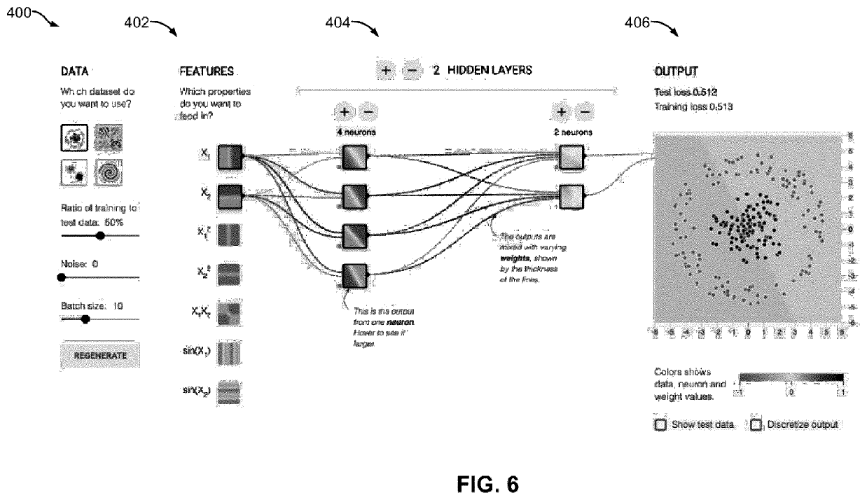

FIG. 6 is a schematic diagram of a neural network 400. As shown, the neural network 400 comprises an input layer 402 for receiving data with relevant features for training, a plurality of hidden layers 404, and an output layer 406 for outputting updated or optimized parameters of the data-analysis model. Each hidden layer 404 comprises a plurality of nodes (also called “neurons”).

Each node comprises a plurality of inputs and an output, and calculates the output value by applying an activation function (for example, a nonlinear transformation) to a weighted sum of input values. Each input of a node is connected to the outputs of a plurality of nodes in a preceding, neighboring layer (which may be the input layer or a preceding, neighboring hidden layer, depending on the location of the node) and the output of a node is connected to the inputs of a plurality of nodes in a following, neighboring layer (which may be a following, neighboring hidden layer or the output layer), thereby creating complex nonlinearities.

As described above, the AI-based data-processing module 204 may use data collected from various sources for training or otherwise optimizing the data-analysis models and may use the trained data-analysis models for analyzing collected data and making predictions. The training may initially start with small datasets from trusted data sources for ensuring data quality. A set of variables of the data-analysis models are optimized using the datasets. As those skilled in the art will appreciate, the variables to be optimized are key to the data-analysis models and need to be carefully selected. The datasets for training each data-analysis model may preferably be particular and unique thereto. Moreover, the quantity of data may depend on the complexity of the data-analysis model.

With increasing numbers of processed datasets, the data-analysis models are repeatedly trained or optimized and consequently, the accuracy of predictions made based on the data-analysis models is improved.

As those skilled in the art will appreciate, machine learning may not be fully autonomous. In some embodiments, the e-commerce system 100 may allow authorized users such as system designers and/or system administrators to input instructions to refine and tune the machine-learning process.

### System Security Architecture

Those skilled in the art will appreciate that the e-commerce system 100 may require an enhanced security architecture for protecting users and transactions thereof.

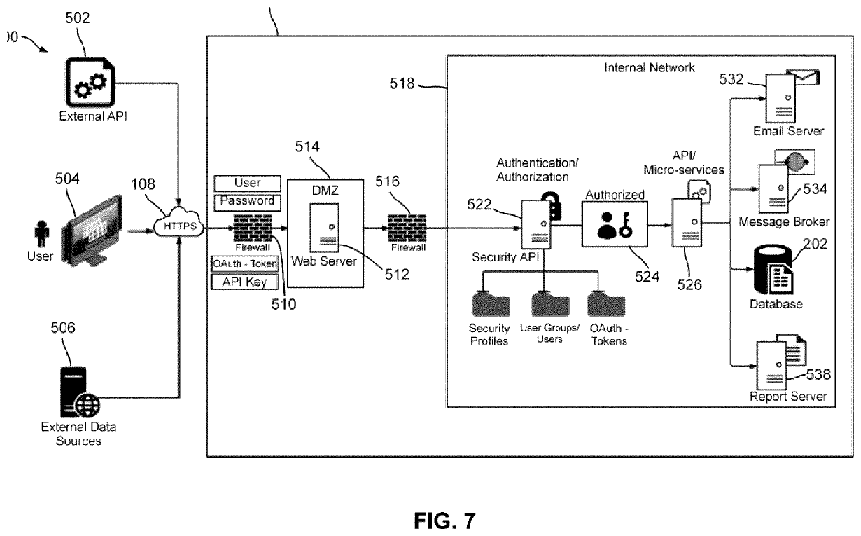

FIG. 7 shows the security architecture 500 of the e-commerce system 100 in some embodiments. As shown, the external sources such as third-party systems connected through the external API 502 (which is a part of the API 210), external user devices 504 (which are a part of the client computing devices 104), and various external data sources 506 are connected to the e-commerce system 100 via the network 108 using one or more encrypted or otherwise secured protocols such as the hypertext transfer protocol secure (HTTPS).

Each external source is connected to the system for sending instructions (for example, queries) and data thereto and receiving instructions and data therefrom. Hereinafter, the instructions and data exchanged between an external source and the e-commerce system 100 is denoted a “connection” for ease of description.

Each inbound external-connection (i.e., an external connection initiated from an external source first goes through a first firewall 510 (also denoted an “external firewall”) for authentication using a suitable authentication mechanism such as username/password, tokens (for example, OAuth 2.0 published by the Internet Engineering Task Force of Fremont, Calif., USA), API keys, and/or the like. After authentication, the inbound external-connection is passed to a webserver 512 in a demilitarized zone (DMZ) network 514. As those skilled in the art will appreciate the DMZ network (also called “DMZ zone”) acts as a buffer zone between the external network 108 and the internal network 518 of the e-commerce system 100, and protects the devices such as the webserver 512 therein by providing an interface to the external network 108 and keeping the internal devices 512 separated and isolated form the external network 108. The DMZ network 514 detects and mitigates security breaches before they reach the internal network infrastructure.

Depending on the nature of the inbound external-connection, the webserver 512 may respond by sending a response thereto via the firewall 510 and the network 108.

If the webserver 512 cannot respond to the inbound external-connection, the webserver 512 may pass the inbound external-connection to the internal network 518 through a second firewall 516 (also denoted an “internal firewall”).

Specifically, the inbound external-connection is first passed to an authentication/authorization subsystem 522 for further security check using, for example, relevant security profiles, user and/or user-group access rights, applicable tokens such as OAuth 2.0 tokens, and/or the like. If the inbound external-connection passes the authentication/authorization and becomes an authorized connection 524, the authorized connection 524 is then passed to an API/micro-service subsystem 526 for processing the instructions and data therein with access of the database 202 as needed. The processing results may be stored into the database 202 or sent to one or more subsystems such as an email server 532, a message broker 534, a report server 538, and/or the like, for reporting to the external source via suitable means.

The security architecture 500 may use any suitable technologies for security, encryption, authentication, and authorization, for example, public-key cryptography, cloud encryption, block-chain, and/or the like. The e-commerce system 100 thus may provide enhanced security to internal and external users and data sources.

Various examples of the e-commerce system 100 are now described.

### Example 1

### Advanced AI-Based Verification System for Pre-Qualifying Manufacturers, Products and Service Providers

The e-commerce system 100 may be used as an advanced AI-Based verification system to pre-qualify manufacturers, products and service providers. The advanced AI-Based verification system 100 may automate the pre-qualification process of suppliers, manufacturers, and products and service providers, provide advance verification information, and then rate them on a scale without bias. The use of the AI-Based verification system 100 allows buyers, distributors, wholesalers, and end-user consumers to quickly navigate through verified manufacturers and their product/service offerings and compare the information gathered by the AI-based verification platform against their competitors.

In this example, the e-commerce system 100 is configured for automatically sourcing, tracking, verifying, and compiling all publically available model-relevant data from a plurality of data sources for suppliers, manufacturers, and products. The data may comprise history, regulatory compliance, health, safety, environmental certifications, public financial records, financial risks, pricing, warranty and service terms, reputation, customer testimonials, references, legal history, and overall credibility.

In response to a user's query, manufacturers and/or suppliers and/or distributors and/or products and/or services may then be compared side-by-side and rated on a scale between 1% and 100% based on the positive findings and/or negative findings. The AI-based e-commerce system 100 may detect and alert the user of potential fraudulent businesses and may also list, summarize and/or recommend the top reputable businesses identified with their search criteria.

In this example, access to the data may be limited to geographical regulations and the data that is publically available. The consumption of the data may be handled via APIs. As described above, the frequency of the data feed may vary depending on the data sources.

In this example, information may also be sourced and collaborated with third-party businesses, government or legal entities such as:
Certification Companies, for example, Energy Star, UL, CSA, ISO9000, CEE, and/or the like;
Business Companies, for example, Bloomberg, Ceder, Business Insider, and/or the like;
Social Sites, for example, LinkedIn, Facebook, twitter, Instagram, and/or the like;
Reputation Companies, for example, Better Business Bureau (BBB), Trustpilot, Rippoff Report, and/or the like;
Legal Entities, for example, Federal and local Police, FBI, Homeland Security, Public legal records, and/or the like; and
Award Entities, for example, Ernst & Young Entrepreneur of the Year, SCORE Awards, and/or the like.

Moreover, data transfers may be managed via API's and/or licensed into various third-party e-commerce platforms such as Amazon, Alibaba, EBay, and/or the like.

Thus, the e-commerce system 100, as a SaaS platform, may be enabled for manufacturers, suppliers, and service providers to upload the application pre-qualification information.

In this example, a variety of aspects of the e-commerce system 100 such as the GUI thereof and the information being captured for registration purposes may be customized to adapt to specific industry, product type and geographical area.

Moreover, the e-commerce system 100 may comprise an access control mechanism such that manufacturers, suppliers, and service providers may not have the ability to modify, manipulate, or delete any negative information displayed on the system 100, thereby providing sufficient reliability and credibility to potential customers.

Expressed consent related to the privacy and the use of the data may be required for adhering to data privacy regulations by geographical areas. For example, identifiable information (for example, date of birth, social insurance number, and/or the like) may not be required or may not be captured if possible.

Registered companies may be listed and pre-qualified for a user upon their payment of a subscription fee. Buyers and business-to-business (B2B) consumers and/or business-to-consumer (B2C) companies may subscribe to the e-commerce system 100 to gain access to the registered, prequalified companies in return for payment of a subscription fee.

Corporate buyers/distributors and wholesalers may upload projects/products to the e-commerce system 100 for tender from third parties. In some embodiments, the e-commerce system 100 may comprises a SaaS real-time bidding platform for purchases of goods and/or services, for the prequalified subscribers to compete for. The AI-based e-commerce system 100 may recommend choice selections based on the criteria of the purchaser's procurement needs. Suppliers, manufacturers, and service providers may be charged a commission fee for each winning bid as the system 100 will drive sales for their business.

Data captured with the use of the e-commerce system 100 may be monetized as it relates to purchasing trends, demography, geography, and/or the like, which may have great value to suppliers, manufacturers, and service providers.

Therefore, the AI-based e-commerce system 100 may will connect sellers and buyers, and may be used in all industries, all products, and all geographical areas globally.

### Example 2

### Advanced AI-Based Marketing and Sales Automated Solution

The e-commerce system 100 may also be used as an advanced AI-Based marketing and sales automated solution which may allow sellers to create meaningful targeted highly effective campaigns to promote their products and services.

In this example, the e-commerce system 100 may comprise an AI-based product demographic analysis and customer verification tool. Similar to the above-described example of the AI-Based verification system for pre-qualifying manufacturers, products and service providers, both B2C and B2B customers may be verified. B2C consumers may be validated by leveraging big data such as social media presence and the like, and B2B businesses may be validated based on a plurality of data sources and third-party subscription services.

In this example, the e-commerce system 100 may also provide data solutions for identifying demographic markets and online marketing vessels (for example, distribution channels). The e-commerce system 100 may further provide low-cost marketing strategies and campaign plans in return for payment of a subscription fee. In addition, the e-commerce system 100 may alternatively provide free, low-cost, or cost-effective marketing solutions to targeted audiences.

In this example, the e-commerce system 100 may provide a data/system solution such that a subscriber may enter a set of parameters via a GUI to allow them to generate a marketing budget and estimate the return on investment (ROI) based on conversions.

In this example, the e-commerce system 100 may be a SaaS system to market and promote specific products and services to targeted audiences by using various tools such as e-mail, content management builder tool, web-based e-commerce site, and/or the like. The e-commerce system 100 may provide links to points-of-purchase via a website (for example, an AI merchant center) and/or to online ordering forms. The e-commerce system 100 may also integrate with enterprise resource planning (ERP) systems and other third-party systems such as logistic companies and/or the like, for sending data thereto and/or receiving data therefrom.

In this example, the e-commerce system 100 may enable lead nurturing automation for automatically building relationships with potential collaboration parties such as clients even if they are not in the process of starting a collaboration or transaction such as buying a product or service. As those skilled in the art will appreciate, lead nurturing automation is important for raising a party's profile and for promoting collaborations or transactions between parties and may be the most critical step of the sales cycle as communicating too little, too much, or with the incorrect information may automatically result in dead leads.

In particular, the e-commerce system 100 may automatically identify targeted content and targeted parties or users based on above-described analysis and automatically sending identified targeted content to identified targeted parties or users via various communication methods such as emails, letters, and/or the like in various formats such as text, images, video clips, audio clips, and/or the like. The e-commerce system 100 may automatically communicating with identified targeted parties or users in a time-sensitive manner and with a predefined frequency or a frequency adaptively determined based on above-described analysis.

As a SaaS system, the e-commerce system 100 may automate customer feedback gathering, customer interaction (for example, sales) and lead follow up and reference submittal requests. The e-commerce system 100 may be able to analyze the customer feedback to learn valuable information about the customer and what they think of the products and services being offered. As those skilled the art will appreciate, knowing the customers may provide meaningful information on how to effectively communicate with them and what is of value to them.

In this example, the e-commerce system 100 exploit the AI functionalities to provide users with customized, specific suggestions of the most effective methods of communicating with their customers such as “how to speak to the customer”, do's and don'ts, frequency, schedule, and/or the like.

### Example 3

### Advanced AI Shopping and Supply Center for Businesses

The e-commerce system 100 may further be used as an advanced AI-Based shopping and supply center for businesses which is an e-commerce SaaS community of pre-verified companies of various manufacturers, suppliers, and purchasers using the above-described advanced AI software verification tools. The service may be aimed at B2B and B2C transactions.

As a SaaS platform the AI-Based shopping and supply center 100 allows sellers to promote their products to be pre-screened and qualified as a reputable and trustworthy source. The pre-qualification will be driven by the above-described Advanced AI-based verification system to pre- qualify manufacturers, products, service providers and customers.

In this example, the AI-Based shopping and supply center 100 may be offered as a subscription service for buyers to access millions of prequalified suppliers, products, and services. The subscription fee may be charged to the buyer and a potential commission fee to the seller as the system will become their sales channel.

The AI-Based shopping and supply center 100 constantly verifies the accuracy and quality of the sellers, buyers, and products, with a variety of features including:
verified buyers and sellers;
each member may have either an online directory or an online store that allows branding, product management, logistics, contract prices (for example, private prices and public prices), and the like;
each user or company may have a ranking based on customer feedback and the analysis results of the above-described AI-based verification system;
ad monetization;
monetization of products/services demographics;
companies may post wanted ads and/or request for proposals (RFPs) for products and services and the system 100 may send the ads and/or RFPs to relevant users and companies of the system with recommendations;
companies may complete online e-commerce purchases utilizing a plurality of payment gateways;
companies may utilize the above-described Advanced AI-Based Marketing and Sales Automated Solution (for example, with additional fees);
the AI-Based shopping and supply center 100 may utilize the above-described Advanced AI-Based Marketing and Sales Automated Solution to pre-qualify and source companies to the AI-Based shopping and supply center 100.

Although embodiments have been described above with reference to the accompanying drawings, those of skill in the art will appreciate that variations and modifications may be made without departing from the scope thereof as defined by the appended claims.

1. A computerized network system for facilitating a plurality of users in e-commerce, the system comprising:
at least one server computer comprising:
a database,
an artificial intelligence (AI) module functionally coupled to the database, the AI module comprising a neural network, and
a data input/output interface coupled to the AI module and the database;
wherein wherein the database, the AI module, and the data input/output interface are configured for:
repeatedly collecting data related to the plurality of users from a plurality of data sources, the data comprising one or more of history, regulatory compliance, certifications, public financial records, pricing records, shipping records, import & export records, purchasing records, reputation, customer testimonials, legal history, credibility, warranty and service terms;
weighting the collected data from each data source based on the frequency of the data collection from the data source;
repeatedly training the neural network of the AI module using the collected data for establishing and optimizing one or more data-analysis models;
analyzing the collected data using the one or more data-analysis models;
generating predictions based on the analysis of the collected data for pre-qualification of the plurality of users as suppliers, manufacturers, and products and service providers with verification information and ratings thereto;
identifying pre-verified users from the plurality of users; and
outputting the generated predictions and/or the pre-verified users to a graphic user interface (GUI).

2. The computerized network system of claim 1, wherein each of the one or more data-analysis models comprises:
a structure for computing a prediction;
weights of the collected data from each data source for said weighting the collected data from each data source; and
biases of the collected data from each data source.

3. The computerized network system of claim 1, wherein the database, the AI module, and the data input/output interface are configured for:
identifying demographic markets and online marketing vessels;
providing marketing strategies and campaign plans; and
generating marketing solutions based on the collected data and using the one or more data-analysis models.

4. The computerized network system of claim 1, wherein the database, the AI module, and the data input/output interface are configured for:
providing links to points-of-purchase and/or to online ordering forms.

5. The computerized network system of claim 1, wherein the database, the AI module, and the data input/output interface are configured for:
automatically identifying targeted content and targeted users based on said analyzing the collected data; and
automatically sending the identified targeted content to the identified targeted users.

6. The computerized network system of claim 5, wherein said automatically sending the identified targeted content to the identified targeted users comprises:
automatically sending the identified targeted content to the identified targeted users with a predefined frequency or a frequency adaptively determined based on said analyzing the collected data.

7. The computerized network system of claim 1, wherein the database, the AI module, and the data input/output interface are configured for:
providing one or more of the pre-verified users an online directory or online store for branding, product management, logistics, and contract prices;
ranking the one or more of the pre-verified users; and
functionally connecting the pre-verified users for completing e-commerce transactions.

8. A computerized method for facilitating a plurality of users in e-commerce using a database, an AI module, and a data input/output interface, the computerized method comprising:
repeatedly collecting data related to the plurality of users from a plurality of data sources, the data comprising one or more of history, regulatory compliance, certifications, public financial records, pricing records, shipping records, import & export records, purchasing records, reputation, customer testimonials, legal history, credibility, warranty and service terms;
weighting the collected data from each data source based on the frequency of the data collection from the data source;
repeatedly training the neural network of the AI module using the collected data for establishing and optimizing one or more data-analysis models;
analyzing the collected data using the one or more data-analysis models;
generating predictions based on the analysis of the collected data for pre-qualification of the plurality of users as suppliers, manufacturers, and products and service providers with verification information and ratings thereto;
identifying pre-verified users from the plurality of users; and
outputting the generated predictions and/or the pre-verified users to a graphic user interface (GUI).

9. The computerized method of claim 8, wherein each of the one or more data-analysis models comprises:
a structure for computing a prediction;
weights of the collected data from each data source for said weighting the collected data from each data source; and
biases of the collected data from each data source.

10. The computerized method of claim 8 further comprising:
identifying demographic markets and online marketing vessels;
providing marketing strategies and campaign plans; and
generating marketing solutions based on the collected data and using the one or more data-analysis models.

11. The computerized method of claim 8, further comprising:
providing links to points-of-purchase and/or to online ordering forms.

12. The computerized method of claim 8, further comprising:
automatically identifying targeted content and targeted users based on said analyzing the collected data; and
automatically sending the identified targeted content to the identified targeted users.

13. The computerized method of claim 12, wherein said automatically sending the identified targeted content to the identified targeted users comprises:
automatically sending the identified targeted content to the identified targeted users with a predefined frequency or a frequency adaptively determined based on said analyzing the collected data.

14. The computerized method of claim 8,
further comprising:
providing one or more of the pre-verified users an online directory or online store for branding, product management, logistics, and contract prices;
ranking the one or more of the pre-verified users; and
functionally connecting the pre-verified users for completing e-commerce transactions.

15. One or more non-transitory computer-readable storage devices comprising computer-executable instructions for facilitating a plurality of users in e-commerce using a database, an AI module, and a data input/output interface, wherein the instructions, when executed, cause a processing structure to perform actions comprising:
repeatedly collecting data related to the plurality of users from a plurality of data sources, the data comprising one or more of history, regulatory compliance, certifications, public financial records, pricing records, shipping records, import & export records, purchasing records, reputation, customer testimonials, legal history, credibility, warranty and service terms;
weighting the collected data from each data source based on the frequency of the data collection from the data source;
repeatedly training the neural network of the AI module using the collected data for establishing and optimizing one or more data-analysis models;
analyzing the collected data using the one or more data-analysis models;
generating predictions based on the analysis of the collected data for pre-qualification of the plurality of users as suppliers, manufacturers, and products and service providers with verification information and ratings thereto;
identifying pre-verified users from the plurality of users; and
outputting the generated predictions and/or the pre-verified users to a graphic user interface (GUI).

16. The one or more non-transitory computer-readable storage devices of claim 15, wherein each of the one or more data-analysis models comprises:
a structure for computing a prediction;
weights of the collected data from each data source for said weighting the collected data from each data source; and
biases of the collected data from each data source.

17. The one or more non-transitory computer-readable storage devices of claim 15, wherein the instructions, when executed, cause the processing structure to perform further actions comprising:
identifying demographic markets and online marketing vessels;
providing marketing strategies and campaign plans; and
generating marketing solutions based on the collected data and using the one or more data-analysis models.

18. The one or more non-transitory computer-readable storage devices of claim 15, wherein the instructions, when executed, cause the processing structure to perform further actions comprising:
providing links to points-of-purchase and/or to online ordering forms.

19. The one or more non-transitory computer-readable storage devices of claim 15, wherein the instructions, when executed, cause the processing structure to perform further actions comprising:
automatically identifying targeted content and targeted users based on said analyzing the collected data; and
automatically sending the identified targeted content to the identified targeted users.

20. The one or more non-transitory computer-readable storage devices of claim 19, wherein said automatically sending the identified targeted content to the identified targeted users comprises:
automatically sending the identified targeted content to the identified targeted users with a predefined frequency or a frequency adaptively determined based on said analyzing the collected data.

21. The one or more non-transitory computer-readable storage devices of claim 15, wherein the instructions, when executed, cause the processing structure to perform further actions comprising:
providing one or more of the pre-verified users an online directory or online store for branding, product management, logistics, and contract prices;
ranking the one or more of the pre-verified users; and
functionally connecting the pre-verified users for completing e-commerce transactions.
